(19) United States
(12) Patent Application Publication
(10) Pub. No.: US 2015/0052091 A1
(43) Pub. Date: Feb. 19, 2015

(54) UNSUPERVISED LEARNING OF ONE DIMENSIONAL SIGNALS

(71) Applicant: Hamadi Jamali, Escondido, CA (US)

(72) Inventor: Hamadi Jamali, Escondido, CA (US)

(21) Appl. No.: 14/387,182

(22) PCT Filed: Jun. 7, 2012
(86) PCT No.: PCT/US12/41358

§ 371 Date: Sep. 22, 2014

(51) Int. Cl. G06N 99/00; G06F 17/16

(52) U.S. Cl. CPC G06N 99/005; G06F 17/16
USPC 706/12

(57) ABSTRACT

A method for unsupervised learning of one dimensional signals includes obtaining a sample vector from a one dimensional signal and storing the sample vector in a computer accessible memory (115) and identifying a higher dimension convex natural space where the surface of the function of a constant modulus (CM) performance measure of the sample vector is convex. The method further comprises transforming, with a computational processor (110), the sample vector from an original space into a higher dimension natural convex space CM matrix in the higher dimension natural convex space and solving, with a computational processor (110), for an optimum solution to the CM performance measure in the higher dimension convex natural space. The computational processor extracts an optimum solution to the CM performance measure in the original space.

### BACKGROUND

The identification of patterns and signals from data is fundamental to many disciplines and technologies. Learning the patterns and signals in data allows elements/parameters in a system to be identified, relationships between the elements/parameters quantified, and influence over the system to be established.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of a system for unsupervised learning of one dimensional signals, according to one example of principles described herein.

FIG. 2 shows graphs of parameters and results of a method for unsupervised learning of one dimensional signals, according to one example of principles described herein.

FIG. 3 shows graphs of parameters and results of a method for unsupervised learning of one dimensional signals applied to a non-minimum phase example, according to one example of principles described herein.

FIG. 4 shows graphs of parameters and results of a method for unsupervised learning of one dimensional signals applied to the non-minimum phase example of FIG. 3 but using a greater number of model elements, according to one example of principles described herein.

FIG. 5 shows graphs of parameters and results a method for unsupervised learning of one dimensional signals applied to a non-constant modulus signal, according to one example of principles described herein.

FIG. 6 is a flowchart showing a method for unsupervised learning of one dimensional signals, according to one example of principles described herein.

Throughout the drawings, identical reference numbers designate similar, but not necessarily identical, elements.

### DETAILED DESCRIPTION

The systems and methods described herein provide learning of one dimensional signals, patterns, or dynamic systems from measurements of a correlated signal only and without supervision. The methods are built around calculating the absolute minimum of the constant modulus (CM) minimization problem. In one example, the methods use a finite set of samples from a given one dimensional signal to approximate a signal embedded in a pattern within. The methods work by identifying a higher dimension natural space where the surface of the function is convex. The methods then convert the nonlinear problem to that of a convex optimization in the higher dimensional space with more tractable properties. The estimate of the solution is determined in the computed natural convex space. Then, an estimate of the solution in the original space is extracted from the solution calculated in the computed natural convex space.

One differentiating characteristic of these methods is that they are proven to work when approaches such as the Minimum Square Error (MSE), Least Squares (LS), Wiener estimation, Kalman filtering, and Least Mean Square (LMS) are known to fail. Moreover, due to the method's bandwidth efficiency, mathematical tractability, and ability to do away with training of the algorithm using training sets, the proposed methods stands as a compelling alternative even in situations where other algorithms have enjoyed widespread use.

These methods offer at least three significant benefits over the conventional CM algorithm, which is the most successful blind adaptive method in the area: (1) the methods converge everywhere with a reasonable order O(n²) time complexity; (2) the methods perform well in the presence of non-CM or higher order composite signals such as multiple symbol quadrature amplitude modulation (M-QAM) constellations; and (3) the behavior of the methods is well understood when used with a truncated filter, a non-minimum or mixed phase system, or an additive noise is present.

The methods are very general and can be deployed in a wide variety of engineering fields including digital signal processing, adaptive filter, image analysis, wireless channel estimation, electronic design automation, automatic control systems, optimal design problems, network design and operation, finance, supply chain management, scheduling, probability and statistics, computational geometry, data fitting and many subareas.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples.

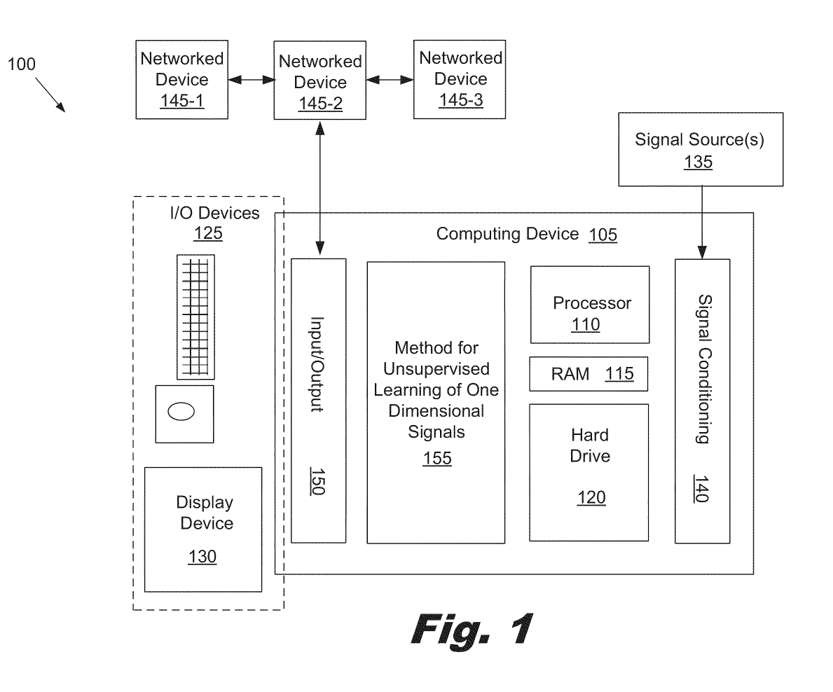

The methods and principles described herein can be implemented by at least one computing device. FIG. 1 shows a system (100) for unsupervised learning of one dimensional signals that includes at least one computing device (105). In this example, the computing device (105) may include a variety of components, including a computational processor (110), a random access memory (RAM) (115), and a hard drive (120).

The processor (110) represents the ability of the computing device to accept and execute instructions to implement the method for unsupervised learning of one dimensional signals (155). The processor may be a single core processor, a multi-core processor, a combination of a general purpose processor and a math co-processor, a graphics processor, or processing capability that is distributed across multiple computing devices.

The RAM (115) and hard drive (120) represent the ability to store instructions for implementing the principles described herein in a manner that is accessible by the processor. All or portions of this memory capacity may be local to the processor or in a remote location. The memory capability may be implemented in a variety of ways, including any presently available architecture or architecture that is developed in the future. For example, the memory may include flash memory, magnetic memory, optical memory, nonvolatile random access memory (nvSRAM), ferroelectric random access memory (FeRAM), megnetoresistive random access memory (MRAM), phase change memory (PRAM), memristive based memory, resistive random access memory (RRAM), or other types of memory. In some instances a single type of memory may serve the function of both the RAM and the hard drive.

A variety of input/output devices (125) may be connected to the computing device including accessories such as a keyboard, mouse, cameras, display device (130), network connection, wireless connection, and other devices.

A signal source (135) produces the signal that is to be operated on. The signal source (135) may be external or internal to the computing device (105). For example, the signal source (135) may be a measurement of environmental parameters using a sensor or a network of sensors. Alternatively, the signal source (135) may be generated by the computing device (105) itself or by an external computing device.

In some implementations, signal conditioning (140) may be included in the system to perform desired operations on the electronic signals prior to processing. For example, the signal conditioning may include analog-to-digital conversion, filtering, and amplification. The signal conditioning may be performed by the computing device itself or by an external component such as a data acquisition system.

The computing device (105) shown in FIG. 1 is only one example of a device or system of devices that could be used to implement the principles described. The methods and principles described herein may be implemented in a variety of ways including in distributed computing environments, in parallel computing architectures, or in other suitable ways. For example, computational processes and/or results could be sent to a number of networked devices (145) through an input/output module (150).

### 1. Problem Solved

Given an n×1 vector Xₜ at time t, with t=0, 1, 2, . . . , N, it is desirable to determine a scalar sₜ and an n×1 vector Wₜ that satisfy the equation:

sₜ=Wₜ*Xₜ (1)

where the superscript (.)* is the complex transpose operator. It is defined as the complex conjugate operator (̅.̅)̅ followed by the transpose operator (.)′.

Typically, for minimum phase systems, Xₜ=[xₜ, xₜ₋₁ . . . xₜ₋ₙ₊₁] is a set of n time samples from a discrete-time complex-valued random sequence {xₜ}. The scalar sₜ is the value at time t of some discrete-time complex-valued random sequence of interest {sₜ}. This sequence is correlated with {xₜ}but is not directly observable. The vector Wₜ=[w_{0,t} w_{1,t} . . . w_{n-1,t}] is a set of n unknown complex-valued parameters at time t representing a finite length linear filter to be designed.

For non-minimum phase systems, only anti-causal representations are stable. As result, the time index is now t=0, −1, −2, . . . , −N. Consequently, the vector Xₜ contains different values of the sample sequence {xₜ} than those from the minimum phase case. The order of the elements in Xₜ is also different since the time index is reversed. However, despite these changes, the model in (1) still holds for these systems also.

The availability of mathematically tractable closed form expressions for the solution of the problem presented above in (1) can significantly advance the understanding and the progression of a variety of scientific and engineering disciplines. In addition, having these equations formulated as iterative algorithms is equally significant for enabling real time implementation of these solutions under practical conditions.

Moreover, training, the hallmark of most learning techniques, is very costly and getting rid of it is extremely beneficial to the design, efficiency, and deployment of the learning approaches. Training involves using a training set to define Wₜ. A training set includes an input vector and a known answer vector. The training set can be used to train a knowledge database or a weighting matrix Wₜ to predict the answer vector given the input vector. After training, the weighting matrix can be applied to a new input vector to predict the answer. This is a form of supervised learning. However, obtaining a training set is logistically costly and implementing the training is computationally costly. The techniques described below eliminate the need for training in solving Equation (1) above.

As presently stated, the problem in (1) is ill-posed. One approach for addressing this issue is to select a vector Ŵ that minimizes the Constant Modulus (CM) performance measure J_{w} given by:

$${J}_{w} = \frac{1}{4} E [ {( {\vert {y}_{t} \vert}^{2} - γ )}^{2} ] \qquad ( 2 )$$

where yₜ is the actual output of the filter Wₜ at time t, Ŵ is the optimum choice with respect to J_{w} for Wₜ, ŷₜ=Ŵ*Xₜ is the CM approximation to sₜ,

$$γ = \frac{E [ {\vert {s}_{t} \vert}^{4} ]}{E [ {\vert {s}_{t} \vert}^{2} ]}$$

is the dispersion constant of {sₜ}, E[.] is the mathematical expectation operator, and |.| is the modulus of the sequence in question.

An iterative method for calculating Ŵ is the Constant Modulus Adaptive (CMA) algorithm given as:

Wₜ=Wₜ₋₁−μεₜyₜXₜ (3)

with εₜ=|yₜ|²−γ been the output dispersion error at time t, εₜyₜXₜ an instantaneous estimate at time t of the gradient of J_{w} with respect to Wₜ, and μ the step size adaptation constant.

The CMA algorithm in (3) is termed blind or unsupervised because it does not require training or a template of the desired signal. This algorithm can be applied in a number of signal processing applications including QAM signals restoration, PAM and FM signals equalization, decision directed equalization, multilevel AM signals recovery, beamforming, antenna arrays, high definition television, non-minimum phase systems identification, signal separation, communication modem design, interference cancellation, image restoration, Gigabit Ethernet equalization, and multiuser detection among others.

Taking a closer look at the problem formulation in (1), it is apparent that the CM minimization is an extension of the Minimum Square Error (MSE) or Wiener estimation problem where both the vector Xₜ and a template of the desired signal {sₜ} are assumed to be known. Consequently, the CM minimization can conceivably be used to replace the more conventional methods such as MSE, Wiener detection, Kalman filter, least squares (LS) method, least mean squares (LMS) algorithm and their many variations. This in turn, extends the applicability of the CMA algorithm to other fields such electronic design automation, automatic control systems, optimal design problems, network design and operation, finance, supply chain management, scheduling, probability and statistics, computational geometry, data fitting and many other areas.

It turns out however, that the CM criterion of (2) has multiple minima. In other words, the optimum vector Ŵ derived using the CMA algorithm of (3) is not unique after all. Hence, while the CM formulation is successful at constraining the number of solutions to the problem in (1), it does not totally resolve the issue of ill-definition. Additionally, a challenging aspect in using the CMA algorithm in practice is that there are no known closed form expressions for the stationary points of the cost function in (2). As a result, there are no known conditions to ensure that (3) converges to the absolute minima rather than the local ones. Consequently, there continues to be a strong need for both closed form and iterative solutions to the problem in (1).

### 2. Principles for Unsupervised Learning of One Dimensional Signals

The discussion below introduces new optimization methods that use only a finite set of samples from a given one dimensional signal {xₜ} to approximate a signal {sₜ}embedded in {xₜ}, a pattern within {xₜ}, or the parameters Wₜ of a dynamic system that maps {xₜ} to {sₜ}. Like the CMA algorithm of (3), the proposed approach does not require a template for the unknown signal to be available for training purposes.

The method works by first identifying a natural space where the surface of the function in (2) is convex. Assuming that the system of interest Wₜ has n parameters, this natural space of convexity is made up of at least n² dimensions. Having converted the original nonlinear problem into that of a convex optimization in a higher dimensional space but one with more tractable properties, the optimum natural convex space CM matrix \hat{Θ} is derived using a Wiener filter like approach. As a result, the obtained solution is implemented using variations of the standard methods such as the Steepest Decent (SD), Newton Method (NM), LS method, LMS algorithm, Recursive Least Squares (RLS) and the many variations of these methods from the literature.

Finally, the estimate Ŵ of the original system is selected as a rank 1 approximate of the computed optimum natural convex space CM matrix \hat{Θ}. Specifically, in a first implementation, the closed form or off-line rank 1 approximate solution to the problem in (1) is calculated as described below.

### 2.1 Closed Form CM Rank 1 Approximation

Given N+1 observations x₀, x₁, . . . , x_{N} from the sample sequence {xₜ}, the n²×1 correlation vector P_{φ}=E[φₜ] and the n²×n² fourth order moment matrix R_{φφ}=E[φₜφₜ*] where φₜ= X̅ₜ [symbol] Xₜ is the n²×1 Kronecker product of the sample vector Xₜ. Given also the dispersion constant γ of the sequence of interest {sₜ} and assuming that x₋₁=x₋₂= . . . =x₋ₙ₊₁=0 with N>>n, the closed form rank 1 approximation of the CM global minima is given by:

$$\begin{matrix}\hat{θ} = γ {R}_{ϕϕ}^{- 1} {P}_{ϕ} & ( 4 ) \\ Θ = matrix ( \hat{θ} , n ) & ( 5 ) \\ [ U , Σ , V ] = svd ( Θ ) & ( 6 ) \\ \tilde{W} = \sqrt{{σ}_{1}} U ( : , 1 ) & ( 7 ) \\ \hat{W} = \frac{\tilde{W}}{{\tilde{w}}_{0}} \\ If ( MinimumPhase ) & ( 8 ) \\ {X}_{k} = [ {x}_{k} {x}_{k - 1} … {x}_{k - n + 1} ] \\ Else & ( 9 ) \\ {X}_{k} = [ {x}_{N - k - n + 1} {x}_{N - k - n + 2} … {x}_{N - k} ] & ( 10 ) \\ {\hat{s}}_{t} = {\hat{W}}^{*} {X}_{k} & ( 11 )\end{matrix}$$

The symbol matrix (θ, n) stands for the operator that converts an n²×1 vector θ into an n×n matrix where the i^{th} column is made up of the n consecutive elements of θ starting at 1+(i−1)n and ending at n+(i−1)n, with i=1, 2, . . . , n. The operator svd(Θ) represents the Singular Value Decomposition methods that map the matrix Θ into two orthogonal matrices U and V and a diagonal matrix Σ. The quantities σ₁ and U(:,1) are the largest singular value and its corresponding left singular vector of the matrix Θ. The variable MinimumPhase is set to 1 if the system is minimum phase and zero otherwise. The element \tilde{w}₀ is the first component of the vector \tilde{W}.

The closed form CM rank 1 approximation presented in (4)-(11) describes the exact global minima of the CM minimization problem in (1) only if the system is perfectly modeled and free of noise. Otherwise, the equations in (4)-(11) provide a rank 1 approximation only to these minima. This is because, the formulas in (4)-(11) minimize a totally different function than the CM cost. In general, the global minima of the new cost function are in the vicinity of the absolute minima of the CM function in (2) but there is a gap between the two sets of values. However, this gap is small when the model in (1) is an adequate representation of the true system. The gap goes to zero only when the estimated signal {yₜ} matches perfectly the unknown signal {sₜ}.

The approach in (4)-(11) can be used independent of the nature of the sequence of interest {sₜ}. However, the accuracy of this method in the presence of composite non-CM or high order M-QAM signals can be improved by using the following non-CM closed form rank 1 approximation to the CM minimization instead.

### 2.2 Closed Form Non-CM Rank 1 Approximation

Given the n²×1 cross correlation vector P_{sφ}=E[|sₜ|²φₜ] and the other variables as defined in the case of the closed form CM rank 1 approximation, the closed form non-CM rank 1 approximation of the CM global minima is given by preserving all the equations (5)-(11) and changing equation (4) as follows:

\hat{θ}=R_{φφ}⁻¹P_{sφ} (12)

The non-CM rank 1 approximation can yield more accurate results in the case of non-CM signals such as M-QAM constellations. However, by requiring the cross correlation vector P_{sφ} instead of the dispersion constant γ and the autocorrelation vector P_{φ}, the non-CM rank 1 approximation to the CM minimization problem can no longer be termed blind. Nevertheless, in cases where the vector P_{sφ} is known or easily computed, it may still be more advantageous to use the non-CM rank 1 approximation than the more common MSE approach.

However, in situations where such knowledge is not readily available, the slight degradation in accuracy that may result from using the CM rank 1 approximation is not catastrophic and does not justify switching to other methods. In fact, what might be lost in accuracy is more than made up for by the advantages afforded by the CM rank 1 approximation including the ease of use, the substantial savings in bandwidth, the favorable convergence properties, and the ability to avoid training.

Applications with limited computing resources typically avoid the direct matrix inversion in (4) because of its computational complexity. In this case, variations of the closed form CM rank 1 approximation method in (4)-(11) can be obtained by employing any efficient algorithm for solving systems of linear equations that will help reduce the computation cost of equation (4). Other variations of the closed form CM rank 1 approximation method can also be derived by utilizing any acceleration algorithms to speed up the calculations of the singular value decomposition in (6).

Additionally, exact expressions for the high order statistical moment matrices P_{φ} and R_{φφ} needed in (4) are not typically available a priori in a number of practical situations. In this case, these moments can be estimated from measurements of the sample sequence as described below.

### 2.3 High Order Statistical Sample Moments

Given N+1 observations x₀, x₁, . . . , x_{N} from the sample sequence {xₜ}, with N>>n. Assuming that x₋₁=x₋₂= . . . =x₋ₙ₊₁=0, the high order statistical moments can be approximated by their sample averages \hat{P}_{φ} and \hat{R}_{φφ} as follows:

$$\begin{matrix}{\hat{P}}_{ϕ , - 1} = 0 & ( 13 ) \\ {\hat{R}}_{ϕϕ , - 1} = 0 \\ For k = 0 to k = N \\ If ( MinimumPhase ) & ( 14 ) \\ {X}_{k} = [ {x}_{k} {x}_{k - 1} … {x}_{k - n + 1} ] \\ Else & ( 15 ) \\ {X}_{k} = [ {x}_{N - k - n + 1} {x}_{N - k - n + 2} … {x}_{N - k} ] & ( 16 ) \\ {ϕ}_{k} = {\overline{X}}_{k} ⊗ {X}_{k} & ( 17 ) \\ {\hat{P}}_{ϕ , k} = {ϕ}_{k} + {\hat{P}}_{ϕ , k - 1} & ( 18 ) \\ {\hat{R}}_{ϕϕ , k} = {ϕ}_{k} {ϕ}_{k}^{*} + {\hat{R}}_{ϕϕ , k - 1} \\ End for & ( 19 ) \\ {\hat{P}}_{ϕ} = \frac{{\hat{P}}_{ϕ , k}}{N + 1} & ( 20 ) \\ {\hat{R}}_{ϕϕ} = \frac{{\hat{R}}_{ϕϕ , k}}{N + 1} & ( 21 )\end{matrix}$$

Once the estimate moments in (20) and (21) have been computed, a new closed form CM rank 1 approximate solution can also be obtained from that in (4)-(11) by substituting the estimates \hat{P}_{φ} and \hat{R}_{φφ} for the unknown values P_{φ} and R_{φφ} and leaving all the other equations unchanged.

The closed form CM rank 1 approximation in (4)-(11) in conjunction with the sample moments of (20) and (21) provides a much needed precise formulas that can be used both as a frame of reference for what the expected solution of the CM minimization problem may be and also as a reliable method for calculating this solution in practical settings. However, this method may not typically be suited for real time or near real time applications without some specialized hardware.

In order to help alleviate this computational difficulty, it is observed that the n²×1 gradient vector of the new convex CM function approximation in the new parameter space turns out to be a system of 3nd order polynomial equations in terms of the parameter vector Wₜ. This particular form is then exploited to use efficient Homotopy continuation methods that are generally faster to compute than the closed form solution of (4)-(11).

### 2.4 Homotopy Continuation Based CM Rank 1 Approximation

Given N+1 observations x₀, x₁, . . . , x_{N} from the sample sequence {xₜ}, the values of the high order statistical moments P_{φ} and R_{φφ} or those of their sample averages \hat{P}_{φ} and \hat{R}_{φφ}, and the dispersion constant γ of the sequence of interest {sₜ}. Assuming that x₋₁=x₋₂= . . . =x₋ₙ₊₁=0 with N>>n, a Homotopy continuation based CM rank 1 approximation is formulated as follows:

1. Record all the components at time t of the gradient vector of the CM cost function J_{w} in (2). For illustration purposes, the τ^{th} element of this gradient, f_{τ,t} is expressed as:

f_{τ,t}=Σᵢ₌^{∞}Σⱼ₌^{∞}Σₖ₌^{∞}w_{i,t} w̅_{j,t}w_{k,t}τ_{φφ}(t−i,t−j,t−k)−γΣ_{k=-∞}^{∞}w_{k,t}p_{φ}(t−k) (22)

2. Then, observe that this representation of the gradient converts the CM minimization problem into that of solving a system of n cubic equations in the n components of the vector Wₜ with constant coefficients involving elements of the second and the fourth order statistical moments of the sample sequence only.

3. Implement a homotopy continuation polynomial equations solver or adapt an existing one from the literature such as PHCpack produced by Jan Verschelde and available through University of Illinois at Chicago. Then, read the constant coefficients into the solver. The returned answer from the solver, the roots of the polynomials in (22), are estimates for the elements of the desired parameter vector Wₜ. These roots can then be used in equation (1) to provide an estimate for the desired signal sₜ.

The boundary limits in (22) are taken to be −∞ and ∞ to cover both the minimum and non-minimum phase systems. In practice, these boundaries are finite and can be used with the solver since these types of systems can always be approximated by a causal Finite Impulse Response (FIR) filter.

Additional computational efficiencies beyond what is possible via homotopy continuations methods are also possible by deriving adaptive or on-line versions of the CM rank 1 approximation in (4)-(11). In one example, a steepest descent (SD) like CM rank 1 approximation solution to the problem in (1) can be described as a steepest descent approximation.

### 2.5 Steepest Decent Based CM Rank 1 Approximation

Given N+1 observations x₀, x₁, . . . , x_{N} from the sample sequence {xₜ}, the n²×1 correlation vector P_{φ}, the n²×n² fourth order moment matrix R_{φφ}, the dispersion constant γ of the sequence of interest {sₜ}, an arbitrary initial value W₋₁, of an unknown but constant n×1 vector Wₜ, and an adaptation constant μ. Assuming that x₋₁=x₋₂= . . . =x₋ₙ₊₁=0 with N>>n, the SD based rank 1 approximation of the CM global minima can be calculated as:

$$\begin{matrix}{θ}_{- 1} = {\overline{W}}_{- 1} ⊗ {W}_{- 1} \\ For k = 0 to k = N & ( 23 ) \\ {∇}_{k} = {R}_{ϕϕ} {θ}_{k - 1} - γ {P}_{ϕ} & ( 24 ) \\ {θ}_{k} = {θ}_{k - 1} - μ {∇}_{k} & ( 25 ) \\ {Θ}_{k} = matrix ( {θ}_{k} , n ) & ( 26 ) \\ {[ U , Σ , V ]}_{k} = svd ( {Θ}_{k} ) & ( 27 ) \\ {\tilde{W}}_{k} = \sqrt{{σ}_{1}} U ( : , 1 ) & ( 28 ) \\ {\hat{W}}_{k} = \frac{{\tilde{W}}_{k}}{{\tilde{w}}_{0 , k}} \\ If ( MinimumPhase ) & ( 29 ) \\ {X}_{k} = [ {x}_{k} {x}_{k - 1} … {x}_{k - n + 1} ] \\ Else & ( 30 ) \\ {X}_{k} = [ {x}_{N - k - n + 1} {x}_{N - k - n + 2} … {x}_{N - k} ] & ( 31 ) \\ {\hat{s}}_{k} = {\hat{W}}_{k}^{*} {X}_{k} & ( 32 )\end{matrix}$$

It is of note to recall here that the original CMA algorithm of (3) requires the initial vector W₋₁ in (23) to be carefully chosen according to the center tap or some other equivalent methodology as to guarantee that this vector is not null. This is because the adjustment term in the CMA algorithm is equal to zero when the parameter vector is zero. This is not the case with the illustrative algorithm in (23)-(32). In fact, unless a previous knowledge is available about the initial vector W₋₁, this vector can be set to zero without affecting the final solution since the algorithm shown in (23)-(32) converges everywhere. This is a significant benefit because the center tap method is known to fail at times making it impossible to know how to start the CMA algorithm in practical situations.

A variation of the steepest descent based CM rank 1 approximation method in (23)-(32) can be obtained by iterating k from 0 to N for equations (24) and (25) only. This can be done on a specialized processor capable of faster rates than the main processor. Then, at the end of the iteration, one proceeds to implement equations (26)-(32) once only. This can reduce the computational load on both the main and the specialized processor significantly.

Other variations can be implemented using efficient estimates for the statistical moments or efficient methods for solving systems of linear equations as described when discussing the closed form CM rank 1 approximation. Additionally, the SD based CM rank 1 approximation can also be implemented by employing lookup tables for the various constant vectors and matrices used in the algorithm of (23)-(32).

Yet, other variations can also be obtained through the use of General-Purpose computation on Graphics Processing Units (GPGPU) in order to speed up the calculations of equations (24)-(26). These techniques can also be used to improve the speed of computing the SVD decomposition in (27).

The SD based CM rank 1 approximation may also be made faster by using whitening methods to reduce the instabilities resulting from the large eigenvalue spread that plagues this kind of problems.

Another approach to the steepest decent CM based rank 1 approximation can be obtained by transforming it into that of Newton Method based CM rank 1 approximation as described below.

### 2.6 Newton Method Based CM Rank 1 Approximation

The Newton Method Based CM rank 1 approximation is obtained by preserving all the equations in (23)-(32) except for equation (25) which is modified as follows:

θₖ=θₖ₋₁−μR_{φφ}⁻¹∇ₖ (33)

Since the Newton method based rank 1 approximation of the CM minimization differs from the steepest decent based CM rank 1 approximation method in the single equation (25) only, their analysis follows in the same way. In particular, all the methods for improving the SD based CM rank 1 approximation apply to the Newton method based CM rank 1 approximation as well.

The use of the Newton based CM rank 1 approximation may also allow for more efficient matrix inversion approaches to be used or developed in the future. Methods that use systems of equations and do not compute the matrix inversion directly can also be used.

Built on the true statistical moments P_{φ} and R_{φφ}, the steepest decent method is computationally challenging for certain category of hardware. In the following implementation, an LMS based rank 1 approximation algorithm that does not explicitly calculate these higher order statistics is derived as:

### 2.7 Least Mean Squares Based CM Rank 1 Approximation

Given N+1 observations x₀, x₁, . . . , x_{N} from the sample sequence {xₜ}, an initial value W₋₁ of an unknown n×1 vector, a dispersion constant γ, and an adaptation constant μ. Assuming that x₋₁=x₋₂= . . . =x₋ₙ₊₁=0 with N>>n, the LMS based rank 1 approximation of the CM global minima can be calculated as:

$$\begin{matrix}{Θ}_{- 1} = {W}_{- 1} {W}_{- 1}^{*} \\ For k = 0 to k = N \\ If ( MinimumPhase ) & ( 34 ) \\ {X}_{k} = [ {x}_{k} {x}_{k - 1} … {x}_{k - n + 1} ] \\ Else & ( 35 ) \\ {X}_{k} = [ {x}_{N - k - n + 1} {x}_{N - k - n + 2} … {x}_{N - k} ] & ( 36 ) \\ {Φ}_{k} = {X}_{k} {X}_{k}^{*} & ( 37 ) \\ {ɛ}_{k} = {vec}^{*} ( {Θ}_{k - 1} ) vec ( {Φ}_{k} ) - γ & ( 38 ) \\ {\tilde{∇}}_{k} = {ɛ}_{k} {Φ}_{k} & ( 39 ) \\ {Θ}_{k} = {Θ}_{k - 1} - μ {\tilde{∇}}_{k} & ( 40 ) \\ {[ U , Σ , V ]}_{k} = svd ( {Θ}_{k} ) & ( 41 ) \\ {\tilde{W}}_{k} = \sqrt{{σ}_{1}} U ( : , 1 ) & ( 42 ) \\ {\hat{W}}_{k} = \frac{{\tilde{W}}_{k}}{{\tilde{w}}_{0 , k}} & ( 43 ) \\ {\hat{s}}_{k} = {\hat{W}}_{k}^{*} {X}_{k} & ( 44 )\end{matrix}$$

Here also, the initial vector W₋₁ in (34) does not need to be specially chosen and can be set zero without affecting the final solution since the method converges everywhere. The LMS based CM rank 1 approximation method can further be improved using the same techniques listed above for the case of the SD like based CM rank 1 approximation. The steepest descent, Newton method, and least mean squares based CM rank 1 approximations are formulated in terms of the adaptation constant μ. However, unlike the conventional adaptive algorithms that are built on the second order statistics only, the iterative techniques describe herein are based on higher order statistical moments instead. A constant μ in this case and all other cases can be selected as follows.

### 2.8 The Adaptation Constant

The choice of the adaptation constant μ is a determining factor in the stability of any adaptive algorithm. One method for selecting μ is:

$$0 < μ < \frac{2}{{λ}_{max}} \qquad ( 45 )$$

where λₘₐₓ the largest eigenvalue of the fourth order moment matrix R_{φφ} and not the standard correlation matrix as is the case in the conventional LMS setting. Other methods for determining the upper bound for μ using the first diagonal element or the trace of the matrix R_{φφ} are also possible.

### 3. Examples

Three examples are given below illustrate the merits of the methods for unsupervised learning of one dimensional signals described above. The first example shows that the methods yield an exact solution in the case when the model in (1) is a perfect representation of the desired system. In the second example, the true system is non-minimum phase with an infinite memory solution. The methods described above lead to a truncated estimate that is stable, robust and computationally efficient. Example three highlights the efficiency of the algorithms described above in the presence of noise and non-CM higher M-QAM signals.

### 3.1 Perfect Model Example

Consider the following scenario: Use Matlab to generate N=100 samples of a random sequence {sₜ} with values of ±1±i; Run these samples through a dynamic system represented by the parameter vector Wₐ=[1 0 −0.4500 0 0.0324] to generate the corresponding 100 samples of a sequence {xₜ} according to the model in (1). Now assume that only the 100 samples from the sequence {xₜ} are available. Assume also that one desires to find estimates for both the vector Wₐ and the samples from the sequence {sₜ}.

Generating the high order statistical moments in (13)-(21) and running the dosed form CM rank 1 approximation in (4)-(11), it is determined that the matrix Θ in (5) has only one nonzero singular value σ₁=1.2035 confirming that Θ is indeed a rank 1 matrix. Further, Ŵ and ŝₜ are computed using (8) and (11) are indeed equal to the true Wₐ and sₜ respectively.

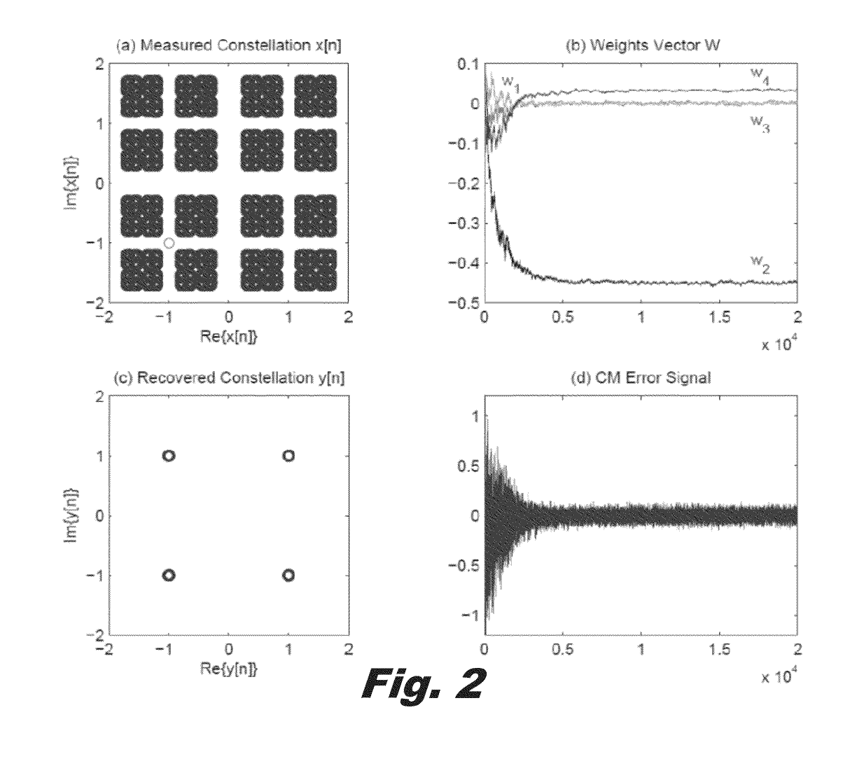

A typical behavior of the LMS based CM rank 1 approximation adaptive algorithm in (34)-(44) is documented in FIG. 2 for an initial vector W₋₁ of zero, μ=0.001 and N=20000.

FIG. 2(a) shows the measured sequence {xₜ} as a cloud with no discernible structure. FIG. 2(b) shows the 5 components of the estimated weights vector converging to their true values. For better clarity, w₀ is not shown since (43) ensures that this element is always normalized to 1. FIGS. 2(c) and 2(d) show the recovered sequence {ŝₜ} and the CM error εₜ respectively.

In contrast, note that the original CMA algorithm fails to converge when run with the same example and the same value of μ regardless of initial conditions. Also note that the other standard methods such as Minimum Square Error (MSE), Wiener filter, and the least squares (LS) cannot be used here since there not enough information about the model to be able to set up such methods.

### 3.2 Non-Minimum Phase Example

Consider the same set up as in Example 1 and generate N=1000 samples of the sequence {xₜ}according to the non-minimum phase relationship sₜ−0.7sₜ₋₁+0.4sₜ₋₂=0.2xₜ+0.7xₜ₋₁+0.9xₜ₋₂.

In this case, the vectors W and Xₜ need to be of infinite lengths for the model in (1) to hold. However, it is typical in practice to truncate such systems to more manageable finite lengths. Assume for instance a vector Wₜ of length 5 only and generate the sample moments in (13)-(21) and the closed form CM rank 1 approximation in (4)-(11) for N=1000.

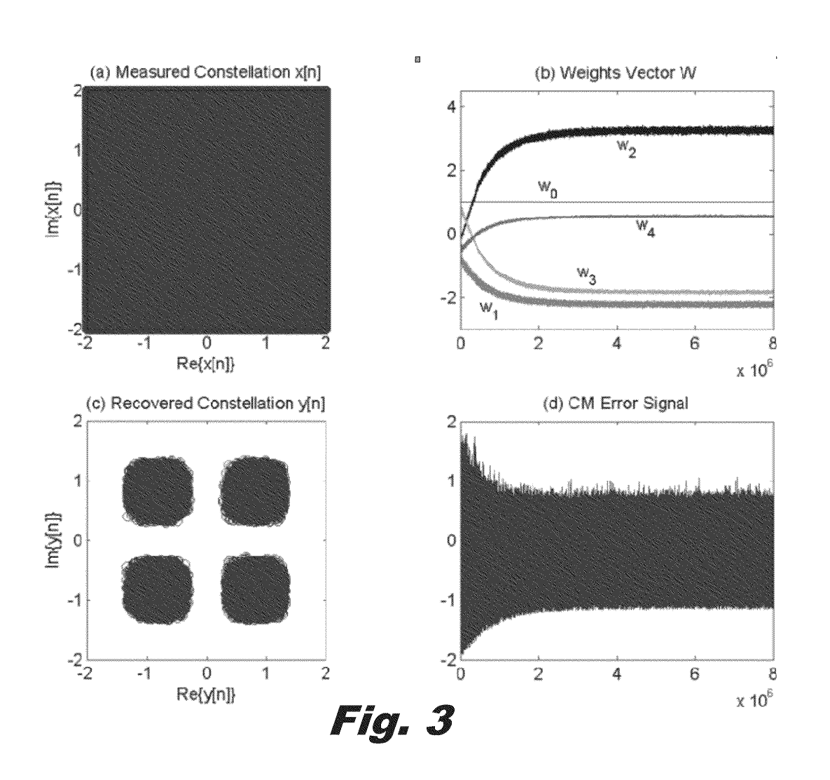

In this scenario, the matrix Θ in (5) has the following 5 nonzero singular values σ₁=23.4398, σ₂=0.9059, σ₃=0.1727, σ₄=0.0777, and σ₅=0.0609. This confirms that Θ is not a rank 1 matrix in this example. The elements of Ŵ are w₀=1, w₁=−2.1682−0.0064i, w₂=3.1417+0.0200i, w₃=−1.7751−0.0197i, and w₄=0.5337+0.0019i. A graph of these values is shown in FIG. 3a. These values are relatively close but different from the first 5 elements of the true system.

The results of the LMS based CM rank 1 approximation adaptive algorithm in (34)-(44) with a 5 elements parameter vector are shown in FIG. 3 for an initial vector W₋₁ of zero, μ=0.0001 and N=200000. FIGS. 3(c) and 3(d) show the recovered sequence {ŝₜ} and the CM error εₜ respectively.

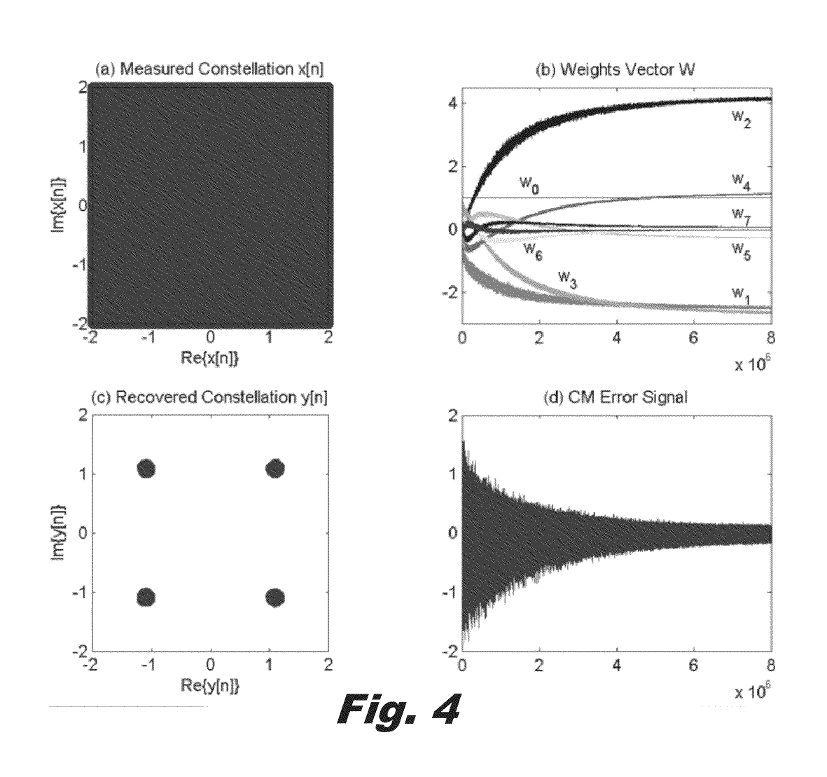

Increasing the length of the model to 9 elements yields a much tighter approximation to the infinite case model as shown in FIG. 4 where both the vector Ŵ and the signal ŝₜ are seeing to closely track their respective true values. FIG. 4(a) shows the measured sequence {xₜ} as a cloud with no discernible structure. FIG. 4(b) shows the 8 components of the estimated weights vector converging to their true values. FIGS. 4(c) and 4(d) show the recovered sequence {ŝₜ} and the CM error εₜ respectively.

### 3.3 Non-CM Signals Example

Use the same true dynamic system Wₐ as in example 1 with a more complicated non-CM pattern given by a 64-QAM sequence {sₜ}.

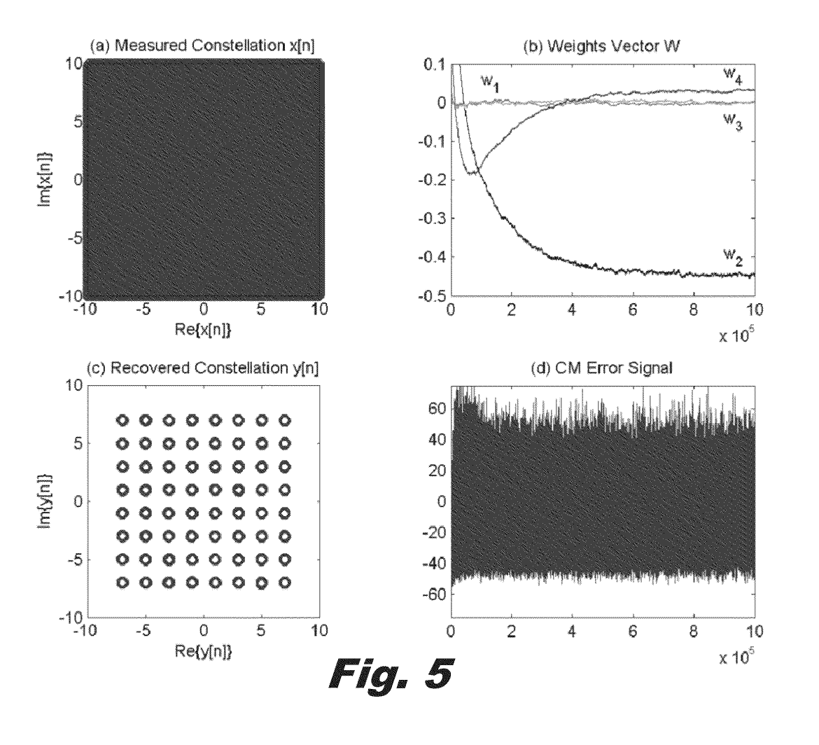

The same analysis as for the previous examples holds in this case. FIG. 5 shows the LMS based CM rank 1 approximation adaptive algorithm in (34)-(44) with a 5 elements parameter vector, an initial vector W₋₁ of zero, μ=10⁻⁸ and N=1,000,000. FIG. 5(a) shows the measured sequence {xₜ} as a cloud with no discernible structure. FIG. 5(b) shows the 5 components of the estimated weights vector converging to their true values. FIGS. 5(c) and 5(d) show the recovered sequence {ŝₜ} and the CM error εₜ respectively.

### 4. Method for Unsupervised Learning of One Dimensional Signals

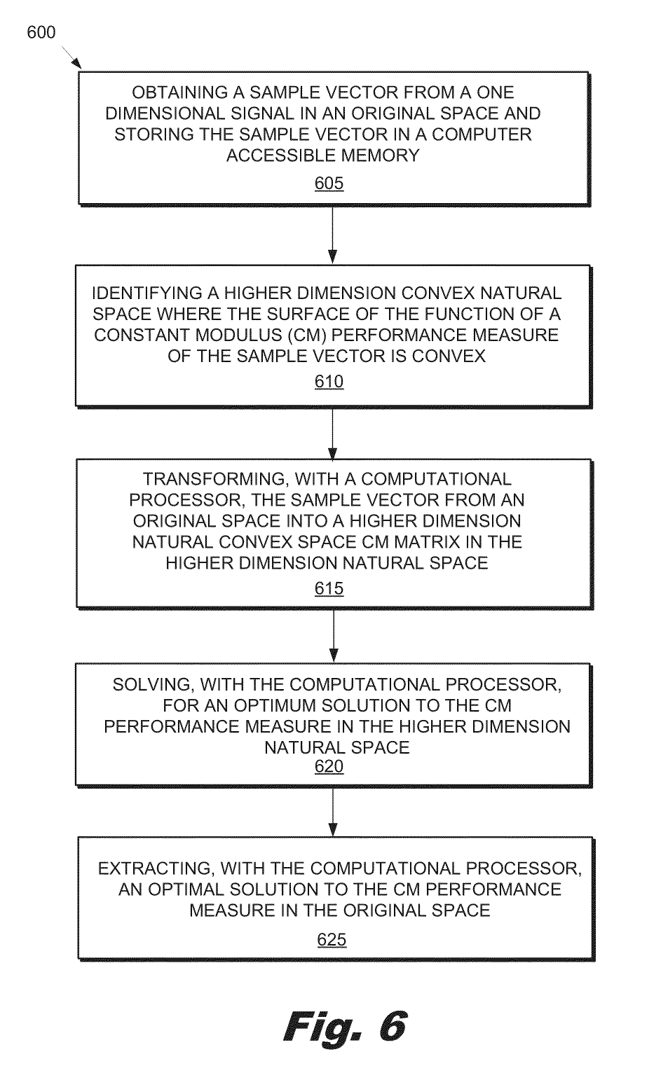

FIG. 6 is a flowchart showing a method for unsupervised learning of one dimensional signals. The method includes obtaining a sample vector Xₜ from a one dimensional signal {xₜ} and storing the sample vector in a computer accessible memory (block 605). This sample vector resides in an original space. A higher dimension convex natural space is identified where the surface of the function of a constant modulus (CM) performance measure of the sample vector is convex (block 610). Identifying the higher dimension convex natural space may be performed by determining a desired number n of parameters in a weighting vector, in which the higher dimension convex natural space comprises at least n² dimensions.

A computational processor is used to transform the sample vector from its original space into a higher dimension natural convex space CM matrix Θ (block 615). For example, the sample vector may be transformed by calculating a Kronecker product of the complex conjugate of the sample vector and the sample vector as given by φₜ= X̅ₜ [symbol] Xₜ. A correlation matrix P_{φ}=E[φₜ] and moment matrix R_{φφ}=E[αₜφₜ*] can be calculated from the Kronecker product. The correlation matrix and moment matrix can then be used to derive the natural convex space CM matrix Θ. In some examples, the correlation matrix is a second order matrix and the moment matrix is a fourth order matrix. In examples that use iterative solutions, an adaptation constant μ for the system can be selected based on the moment matrix.

The computational processor is used solve for an optimum solution to the CM performance measure in the higher dimension natural convex space (block 620). For example, the optimum solution may be found by determining a global minimum of the higher dimension natural convex space CM matrix. The computation processor extracts an estimate of the solution in the original space from the optimum solution in the higher dimensional space (block 625). For example, this estimate may take the form of the weighting matrix W which can be applied to the sample vector to produce the desired value sₜ.

The principles described above can be applied to produce a range of solutions including closed form CM rank 1 approximations and closed form non-CM rank 1 approximation. Additionally, the principles described above can be used to produce iterative solutions that include applying methods such as Steepest Decent (SD), Newton Method (NM), Least Squares (LS), Least Mean Squares (LMS), Recursive Least Squares (RLS), and variations thereof. Such iterative solutions are beneficial in situations where the correlation matrix and moment matrix are not known a priori. In situations where some estimates of the elements of the correlation matrix and moment matrix are known a priori, the method may further include a homotopy continuation based CM rank 1 approximation solving a system of n cubic equations in the n components of a weighting matrix/vector, in which the cubic equations comprise constant coefficients involving elements of the correlation matrix and moment matrix of the sample vector only. The roots of the n cubic equations are estimates for the elements of the weighting matrix.

In some examples, the method for unsupervised learning of one dimensional signals is characterized by: a computational time complexity proportional to n², where n is the number of elements in a weighting; converging to find an absolute minimum regardless of initial starting conditions; and effective application to both CM and non-CM signals.

### 5. Advantages

The principles described above introduce new methods for approximating one dimensional signals, patterns or the parameters of a dynamic system using measurements from a related signal only, without requiring a template for the unknown signal. The method is built on the CM performance measure rather than the more conventional Minimum Square Error (MSE) criterion. This allows it to be used cold without any a priori training on the data to be processed.

A significant benefit of the proposed method is that it is proven to work in situations where other approaches such as Wiener estimation, Kalman filter, LS, LMS, RLS, CMA, or any of their variants, are either not feasible, inappropriate or are simply known to fail as an accurate model for the desired behavior is not available to train on. Additionally, the illustrative methods may be preferred over the traditional algorithms anyway, even in cases where the traditional algorithms have been previously used, because of the ability of the methods described above to conserve bandwidth and eliminate the training phase that is required by various algorithms.

The new method can be deployed in its closed form version, as a homotopy continuation method, or as one of several iterative forms such SD, Newton, or LMS. The iterative implementations of the approach are proven to converge to the vicinity of the global minima of (2) regardless of initial conditions; perform well in the presence of a variety of signals such as higher order QAM signals; withstand disturbances resulting from a truncated filter; reach the desired solution even with non-minimum or mixed phase systems; is robust to additive noise; and has an order O(n²) time complexity only.

Also, by offering unique closed form formulas with well understood convergence properties to the proximity of the true solutions, the CM approximation method outlined in this patent disclosure is suited as a reference for both designers and practitioners to effectively separate between the global and the local minima of the CMA algorithm. This, in turn, will help facilitate a broader adoption of the CM approach.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for unsupervised learning of one dimensional signals comprising:
obtaining a sample vector from a one dimensional signal (135) in an original space and storing the sample vector in a computer accessible memory (115);
identifying a higher dimension convex natural space where a surface of a function of a constant modulus (CM) performance measure of the sample vector is convex;
transforming, with a computational processor (110), the sample vector from the original space into a higher dimension natural convex space CM matrix in the higher dimension convex natural space;
solving, with the computational processor (110), for an optimum solution to the CM performance measure in the higher dimension convex natural space; and
extracting, with the computational processor (110), an optimum solution to the CM performance measure in the original space.

2. The method of claim 1, in which identifying the higher dimension convex natural space where the surface of the function of a constant modulus performance measure is convex comprises determining a desired number n of parameters in a weighting vector, in which the higher dimension convex natural space comprises at least n² dimensions.

3. The method of claim 1, in which transforming the sample vector from the original space into the higher dimension convex natural space CM matrix comprises calculating a Kronecker product.

4. The method of claim 3, in which transforming the sample vector from the original space into the higher dimension natural convex space CM matrix comprises calculating a Kronecker product of a complex conjugate of the sample vector and the sample vector.

5. The method of claim 3, in which transforming the sample vector from the original space into the higher dimension natural convex space CM matrix further comprises:
calculating a correlation matrix from the Kronecker product;
calculating a moment matrix from the Kronecker product; and
deriving the higher dimension natural convex space CM matrix from the correlation matrix and the moment matrix.

6. The method of claim 5, in which the correlation matrix is a second order matrix and the moment matrix is a fourth order matrix.

7. The method of claim 5, further comprising selecting an adaptation constant of the system based on the moment matrix.

8. The method of claim 5, in which estimates for elements of the correlation matrix and moment matrix are known a priori, the method further comprising a homotopy continuation based CM rank 1 approximation solving a system of n cubic equations with constant coefficients involving elements of the correlation matrix and moment matrix of the sample vector only.

9. The method of claim 1, in which solving for the optimum solution to the CM performance measure in the higher dimension convex natural space comprises deriving a rank 1 approximate weighting matrix from the optimum solution to the CM performance measure; the method further comprising applying the weighting matrix to the sample vector to produce a scalar value.

10. The method of claim 1, in which the method for unsupervised learning of one dimensional signals is a closed form CM rank 1 approximation.

11. The method of claim 1, in which the method for unsupervised learning of one dimensional signals is a closed form non-CM rank 1 approximation.

12. The method of claim 1, in which exact expressions for a correlation matrix and a moment matrix are not known a priori, and in which solving for an optimum solution to the constant modulus performance measure comprises in the higher dimension convex natural space comprises applying one of the following solving methods: Steepest Descent (SD), Newton Method (NM), Least Squares (LS), Least Mean Squares (LMS), Recursive Least Squares (RLS), and variations thereof.

13. The method of claim 1, in which the method comprises computational time complexity proportional to n², where n is the number of elements in a weighting matrix in the original space; converges to find an absolute minimum regardless of initial starting conditions; and is effectively applied to both CM and non-CM signals.

14. A method for unsupervised learning of one dimensional signals comprising:
obtaining a sample vector from a one dimensional signal;
identifying a higher dimension convex natural space where the surface of the function of a constant modulus (CM) performance measure of the sample vector is convex by determining a desired number (n) of parameters in a weighting vector in the constant modulus performance measure, in which the higher dimension convex natural space comprises at least n² dimensions;
transforming the sample vector from an original space into a higher dimension natural convex space CM matrix in the higher dimension convex natural space by:
calculating a Kronecker product of a complex conjugate of the sample vector and the sample vector;
calculating a second order correlation matrix from the Kronecker product;
calculating a fourth order moment matrix from the Kronecker product; and
deriving the higher dimension natural convex space CM matrix from the correlation matrix and the moment matrix;
selecting an adaptation constant of the system based on the moment matrix;
solving for an optimum solution to the CM performance measure in the higher dimension natural convex space,
deriving a rank 1 approximate weighting matrix from the optimum solution to the CM performance measure; and
applying the weighting matrix to the sample vector to produce a scalar value;
in which the method comprises computational time complexity proportional to n², converges to find an absolute minimum regardless of initial starting conditions, and is effectively applied to both CM and non-CM signals.

15. A system for unsupervised learning of one dimensional signals comprising:
a computer accessible memory (115);
a computational processor (110) to:
obtain a sample vector from a one dimensional signal and store the sample vector in the computer accessible memory (115);
transform the sample vector from an original space into a higher dimension natural convex space CM matrix; and
solve for an optimum solution to the CM performance measure in a higher dimension natural convex space defined by the higher dimension natural convex space CM matrix.
